(19) United States
(12) Patent Application Publication
(10) Pub. No.: US 2012/0000098 A1
(43) Pub. Date: Jan. 5, 2012

(54) Excavating Device for Excavating Ground Under Water, and Method for Excavating Ground

(76) Inventor: Bart Peter Verboomen, Sint-Lievens-Houtem (BE)

(21) Appl. No.: 13/143,176

(22) PCT Filed: Jan. 7, 2010
(86) PCT No.: PCT/EP2010/050098

§ 371 Date: Sep. 21, 2011

(30) Foreign Application Priority Data
Jan. 10, 2009 (BE) BE 2009/0011
Jun. 5, 2009 (BE) BE 2009/0345

(51) Int. Cl. E02F 5/28; E02F 1/00; G06F 19/00; E02F 3/88; E02F 3/90

(52) U.S. Cl. 37/333; 37/195; 701/21

(57) ABSTRACT

The invention relates to an excavating device, comprising a floating device which can be moved in a navigating direction and to which a drag head (1) is attached which during use is dragged over the bottom (50) and herein loosens soil, and a suction conduit (4) which connects to the drag head (1) and which discharges the loosened soil. The excavating device is provided with a steering device (10) for moving the drag head (1) out of the navigating direction. The invention also relates to a method for excavating ground (50) using the excavating device, and a computer program for performing the method.

The present invention relates to an excavating device for excavating ground under water, which device comprises a floating device which can be moved in a navigating direction and to which a drag head is attached which during use is dragged over the bottom or hangs downward and herein loosens soil, and a suction conduit which connects to the drag head and which discharges the loosened soil. The invention likewise relates to a method for excavating ground under water using this excavating device.

An excavating device according to the preamble is known from EP-A-0892116. EP-A-0892116 describes an excavating device of the trailing suction hopper dredger type. This comprises a vessel to which a drag head is fixed by means of a drag pipe. The drag head is connected to a suction conduit and comprises a visor which is open toward the bottom for dredging. On the visor a series of teeth is arranged on a toothed beam extending in a direction at a right angle to the direction of movement of the drag head. During excavation or dredging the drag head with drag pipe and suction conduit is lowered under water at an oblique angle with a winch at the rear of the trailing suction hopper dredger, until the drag head makes contact with the bottom or hangs downward. During the travel of the trailing suction hopper dredger the drag head is dragged over the bottom under water in the direction of navigation, wherein the soil is loosened by the teeth engaging on the bottom. The loosened soil is suctioned away via the suction conduit, for instance to a storage space present on the trailing suction hopper dredger. During the dredging the drag head exerts pressure on the bottom due to the relatively high weight of the components situated under water, and due to the suction force developed by the suction conduit.

The known excavating device is capable in a short time of excavating large quantities of ground under water. The accuracy of the dredging is however capable of improvement, or is only made possible through the use of expensive and complicated GPS-like control systems such as the DPDT (Dynamic Positioning/Dynamic Tracking) system known to the skilled person in the art. Owing to inaccuracies it may be the case that parts of the area for dredging are not excavated or not properly excavated, whereby the trailing suction hopper dredger must retrace its path. This is time-consuming, thereby reducing the efficiency of the trailing suction hopper dredger. Efficiency is understood in the context of this application to mean the volume of ground dredged per unit of time and per unit of power. The reduced efficiency is caused because in such a case the trailing suction hopper dredger will have to be manoeuvred a great deal, wherein the accuracy of operation is greatly dependent on the experience of the crew and on the power available in the trailing suction hopper dredger. During manoeuvring the trailing suction hopper dredger travels around with downward hanging drag pipe without soil being suctioned up. The same problem otherwise occurs during clearing of local shallows resulting for instance from tracks formed by the drag head.

The present invention has for its object to provide an excavating device which can obviate the above stated drawbacks and with which in particular dredging is possible with greater accuracy than is possible with the known excavating device.

The excavating device according to the invention has for this purpose the feature that it is provided with a steering device for moving the drag head out of the navigating direction. By providing a steering device according to the invention for partially autonomous steering of the drag head it becomes possible to steer the drag head over the ground to a desired zone without it being necessary to manoeuvre the floating device, in particular a trailing suction hopper dredger, to this zone. The desired zone for dredging is hereby not only reached more quickly, this moreover takes place using considerably less power and with greater accuracy. Considerably less fuel is used and CO₂ emitted as a result of the greatly reduced power requirement, this reducing the impact on the environment.

The excavating device can in principle comprise any floating device suitable for the purpose, as long as it can be propelled. Suitable vessels comprise for instance a pontoon moved forward using an auxiliary vessel, a ship along which a second ship with hold space is moored, a cutter suction dredger, a trailing suction hopper dredger and other suitable floating devices. The floating device preferably comprises a trailing suction hopper dredger.

A drag head for a trailing suction hopper dredger can have a weight of more than 20 tonnes. During use the drag head is moreover suctioned with great force onto the ground surface due to the suction action of the suction conduit. It would therefore seem that great power is required to move such a drag head. Surprisingly, it has been found that not a particularly large amount of power is necessary to move the drag head out of the navigating direction. The steering means hereby require moderate power, at least related to the power usually applied in the dredging sector.

Although not strictly necessary, a preferred embodiment of the excavating device according to the invention comprises control means for operating the steering device from the floating device. The accuracy of the excavation is further increased with such a remote control. A crew member on the floating vehicle generally has equipment at his disposal with which the ground surface, and more specifically the depth profile of the ground surface (therefore the unevenness of the ground surface) can be visualized from the waterline. Because this takes place in real-time, this crew member generally has a view of the position of the drag head. The present variant makes it possible to adjust the position of the drag head on the basis of the knowledge of the depth profile of the ground surface.

The steering device according to the invention can be embodied in many ways. A first embodiment of the excavating device according to the invention is provided with a steering device comprising a traction cable which leads from an attachment point on the drag head or on a lower part of the suction pipe, via a support frame arranged on the floating device, to a winch or winding gear likewise arranged on the floating device. The drag head is for instance steered in the port direction by tightening the traction cable on the port side.

A second embodiment of the excavating device according to the invention is provided with a steering device comprising a revolving body such as a caterpillar track, the caterpillar track extending on the contact side of the drag head with the ground surface, this substantially transversely of the dragging direction. The drag head is steered to the right by rotating the revolving body in clockwise direction, and the drag head is steered to the left by rotating the revolving body in counter-clockwise direction.

A third embodiment of the excavating device according to the invention is provided with a steering device comprising a jet pipe, the axis of which runs substantially transversely of the dragging direction. When a high-pressure jet is released in a jet pipe with jet nozzle on the port side, the drag head will be moved in the direction of the starboard side, and vice versa.

A fourth embodiment of the excavating device according to the invention is provided with a steering device comprising a propeller, the rotation axis of which extends substantially transversely of the dragging direction. When the propeller rotates the drag head will be moved in the forward direction of the propeller.

A fifth embodiment of the excavating device according to the invention is provided with a steering device which is adapted to apply a friction force to the bottom which is distributed unequally over the width of the friction surface. The unequal distribution of the friction results in a force which does not lie in the axis of the main direction of movement followed by the travelling ship. A resultant force is created by this play of forces which causes the drag head to move in a direction differing from the main direction of movement followed by the travelling ship. The unequal distribution of the friction force on the friction surface can be obtained by way of example by providing on both outer ends of the drag head a hook which can be pressed under control into the bottom or lifted therefrom. When this hook presses into the bottom, the friction force on the bottom is increased locally and provides for the desired reaction force.

A sixth embodiment of the excavating device according to the invention is provided with a steering device comprising means adapted to shift the reaction force relative to the middle of the drag head as a result of the downward pressure of the drag head on the bottom, whereby the drag head can make a transverse movement. This downward pressure has multiple causes, the main one being the force of gravity, but also the pressure drop over the head caused by the suction process. By shifting the centre of forces (centre of gravity in the case of gravity) of the drag head from the neutral point on the axis of the drag head, a part of the ground reaction force can be shifted in the transverse direction. This corresponds to an apparently lateral force on the drag head. A particularly suitable steering device comprises means adapted to rotate the drag head about the axis of the suction pipe. Both the reaction force of the ground and the friction force of the bottom can hereby be influenced. For this purpose the suction pipe more preferably comprises rotation means for forced rotation of the part of the suction pipe in contact with the drag head, for instance in the rotating joint of the suction pipe, this being a known component of a suction pipe. A suitable rotation means comprises a hydraulic cylinder engaging on the rotating joint. The rotation of the suction pipe part changes the weight distribution of the drag head on the bottom, whereby on the one hand the gravitational force acquires a transverse component, and on the other higher friction occurs locally which provides for friction force, and a lateral movement. It is also possible to have control means in the form of a hydraulic cylinder or other means engage on for instance the suction pipe so that this latter can be pushed away from the floating device, whereby the drag head will move out of the navigating direction. Such a control means can for instance engage on the suction pipe at the level of the deck of the floating device, or just below the cardan joint generally situated below the centre of the suction pipe.

A particularly advantageous seventh embodiment of the excavating device according to the invention is provided with a steering device comprising a rudder blade, wherein the rudder blade extends in a substantially vertical plane and during use engages with a side edge thereof in the ground or in the water. The rudder blade—or if desired a plurality of rudder blades—can be connected to the drag pipe and/or to the drag head, for instance to the visor or to the cap of the drag head. The correct placing of the rudder blade will in many cases depend on the distribution of forces at that location. The rudder blade is preferably mounted in front of the heel plate of the drag head, so that during dragging the rudder blade engages on the flow and/or on the ground surface upstream of the heel plate (and the visor). The forward movement of the floating device, in particular the trailing suction hopper dredger, creates during dredging a reaction force on the rudder blade which pushes the drag pipe suspended from a winch cable in a direction determined by the position of the rudder blade. The drag head is in this way displaced relative to the trailing suction hopper dredger.

During use the rudder blade engages with a side edge thereof in the ground or exerts a reaction force on the surrounding water. For this purpose the rudder blade must preferably be at a sufficiently low position that during dredging the rudder blade is pressed into the ground under the weight of the drag head and suction pipe. Despite the fact that the rudder blade cuts through the ground during use, the associated friction is not found to be significantly greater than is the case for a drag head embodied without rudder blade. As stated, the surrounding water can also provide a reaction force on the rudder blade.

The rudder blade is preferably steered by control means comprising a piston, or hydraulic cylinder, which engages on the rudder blade. For control thereof the cylinder is connected in this embodiment electronically (and optionally wirelessly) to the floating device, in particular the trailing suction hopper dredger. A hydraulic cylinder in particular allows simple and reliable operation of the rudder blade from the bridge of the trailing suction hopper dredger, for instance by the crew member also monitoring the movement of the drag pipe. All the usual auxiliary means, such as for instance a control screen on which the profile of the ground surface is visualized, are advantageous here.

The rudder blade according to the invention must be sufficiently strong to be able to withstand the forces acting thereon. The forces to be overcome lie typically in the order of magnitude of the force exerted by the drag head on the ground surface. For a typical trailing suction hopper dredger such a force is in the order of magnitude of 20 to 30 tonnes, at least when the force is exerted at the position of the drag head, this being preferred. A hydraulic cylinder with a diameter of 15 to 20 cm is able to overcome such forces. Cylinders of such a size are also applied to operate the visor of the known drag head.

The dimensions of the rudder blade, and more specifically the length thereof, and the depth over which the rudder blade presses into the ground, are in principle determined by the resistance which the ground can cause. It is for instance expected in the case of a rudder blade that a ground surface (such as sand), which provides much resistance to a displacement of the drag head, requires a smaller rudder blade than a ground surface providing less resistance (such as silt for instance). A sand-like ground will after all produce a higher reaction pressure on the rudder blade than a silt-like ground. On the other hand however, the friction force which the drag head encounters in a sand-like ground will be higher than in a silt-like ground, which in turn indicates a larger rudder blade. Since the two effects more or less cancel each other out, the dimensions of the rudder blade required for a silt or sand ground are roughly of the same order of magnitude. It is thus possible to apply the same rudder blade for different types of ground, this being an additional advantage.

The drag head can in principle be removed any desired distance away from the trailing suction hopper dredger in the above indicated manner. The maximum possible distance or deviation is determined by, among other factors, the length of the suspending wire of the drag pipe and the angle the suspending wire makes with the horizontal. It is advantageous to provide means to enable measurement of particularly the suspending wire angle. It is hereby possible to avoid the drag pipe becoming too far removed from the trailing suction hopper dredger or even detaching therefrom.

As the drag head becomes further removed, the drag head must preferably maintain contact with the ground surface. This can be realized by lengthening the suspending wire of the drag pipe so that this contact is maintained. Use can advantageously be made here of a per se known swell compensating device. Such a device ensures that the drag head continues to press with the same force on the ground surface during dredging in swell. The same device can also be utilized to ensure that the drag head continues to press with the same force on the ground surface when this drag head is removed from the navigating direction of the trailing suction hopper dredger.

In yet another preferred embodiment the excavating device is provided with a plurality of steering devices, of which examples have been given above, for the purpose of moving the drag head out of the navigating direction. It is thus possible to provide the drag head with a rudder blade, and the suction pipe with a propeller or traction cable. A plurality of steering devices of the same type can also be arranged on the excavating device. Applying a plurality of steering means, also in combination, has the advantage that the reaction force exerted on a steering means by the ground or flow will be lower.

The invention likewise relates to a device for controlling the steering device. The device comprises a central computer which is connected directly or via a digital network to the steering device and which is adapted to perform a method comprising at least the steps of:
A) presetting an optimum criterion,
B) collecting information relating to the current state of the ground,
C) collecting information relating to the current state of the steering device, including at least its setting,
D) calculating the control of the steering device at which the optimum criterion is minimized.

The computer is loaded for this purpose according to the invention with a computer program which comprises program instructions for setting the steering device. The advantages of such a device allow calculation of an optimum. The device according to the invention collects the information via the (digital) network in the form of incoming signals which come from instruments, such as a GPS system, DTM or a DPDT system (non-limitative list), incorporated in the network. These signals are processed, after which the device transmits control signals via the digital network to the steering device for the purpose of controlling this latter, or wherein information is shown on a digital screen, on the basis of which an operator carries out control of the steering device. The computer calculates the control, which preferably comprises at least that route of the drag head which minimizes the optimum criterion (the ‘optimum’ route). The thus calculated control is continuously adjusted by the computer as a function of the changes recorded by the instruments. According to the invention the computer calculation takes into account, among other factors, the position, the processing rate, the navigation speed and the technical possibilities of the trailing suction hopper dredger, and this preferably controls a trailing suction hopper dredger by modifying for instance the position of the visor, the position of the rudder, the position of the drag head and so forth.

The drag head according to the invention is relatively simple to realize and can ensure that much less manoeuvring time is necessary for the purpose of dredging small zones. Dredging can moreover take place much more accurately. Other details and advantages of the invention will become apparent from the following description of an excavating device according to the invention. This description is given solely by way of example and in no way limits the invention. The reference numerals relate to the accompanying figures, in which:

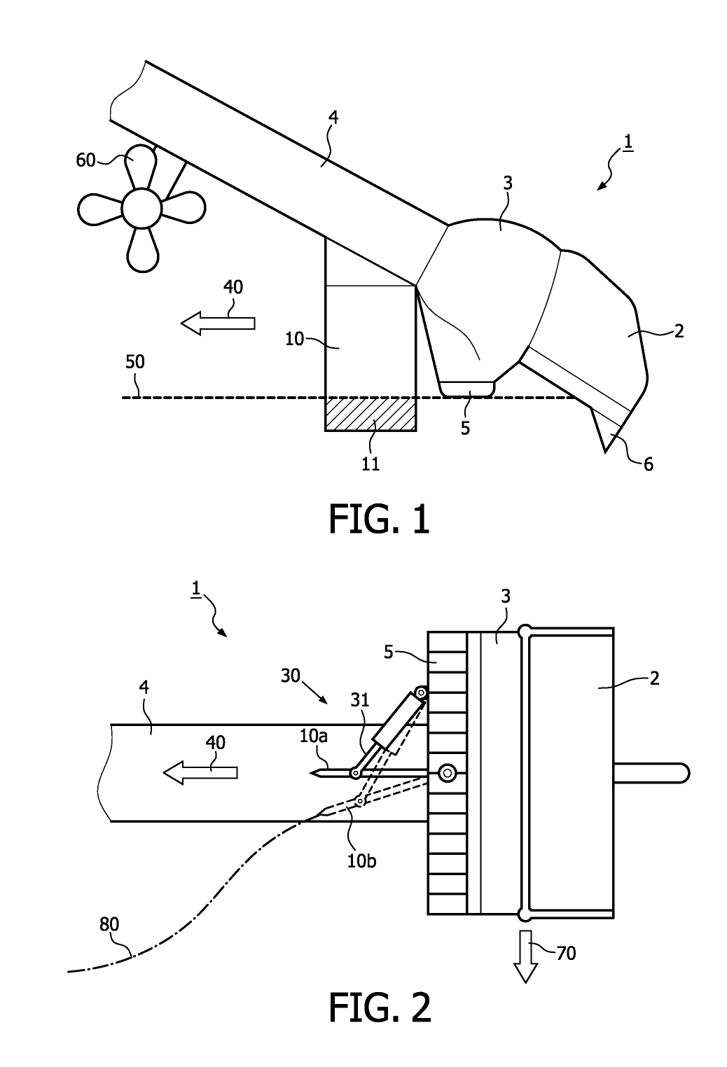

FIG. 1 is a schematic side view of a drag head forming part of the excavating device according to the invention;

FIG. 2 is a schematic top view of the drag head of FIG. 1;

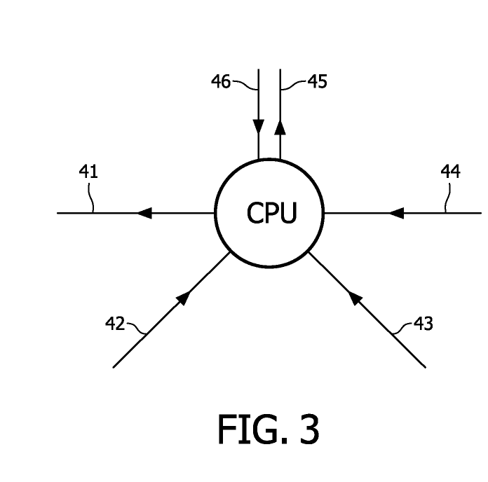

FIG. 3 shows schematically an embodiment of a device according to the invention; and

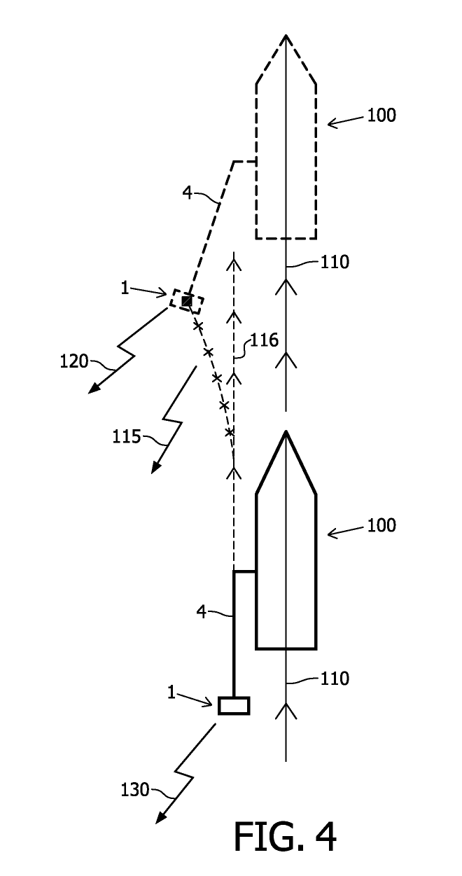

FIG. 4 is a schematic top view of a trailing suction hopper dredger provided with a drag head according to the invention.

Referring to FIG. 1, a drag head 1 according to the invention is shown. Drag head 1 comprises a visor 2 which is dragged over a bottom 50 for dredging. A suction conduit 4 is connected to visor 2 via cap 3. Drag head 1 further comprises a heel plate 5 with which drag head 1 supports on bottom 50 during dredging. Visor 2 is provided with toothed beam 6 (or other excavating device) which incorporates a number of teeth. The toothed beam extends substantially perpendicularly of the dragging direction 40. According to the invention the drag head 1 is also provided with a steering device in the form of a rudder blade 10, which in the shown embodiment variant extends in a substantially vertical plane. This plane will generally lie perpendicularly of bottom 50. During use rudder blade 10 will engage with the lower side edge 11 thereof in bottom 50, and a part thereof will penetrate into the bottom under the weight of the drag head and drag pipe. This part is shown hatched in FIG. 1.

Rudder blade 10 is connected to a hydraulic cylinder 30 (see FIG. 2) which serves as control means for rudder blade 10. In the shown variant hydraulic cylinder 30 is connected to heel plate 5 and on the other side to rudder blade 10 via a piston rod 31. Hydraulic cylinder 30 is further connected electrically to the trailing suction hopper dredger (not shown) so that it can be operated, optionally wirelessly, from this trailing suction hopper dredger. The crew member also monitoring the movement of drag pipe 4 can control rudder blade 10 making use of usual auxiliary means such as for instance a control screen on which smaller unevenness in the ground surface can be visualized. In the position 10a of rudder blade 10 shown in the figure the drag head will be steered in dragging direction 40 as would also be the case for the known drag head. With rudder blade 10 in the position 10b the drag head 1 will vary from the dragging direction and be steered sideways in direction 70. Drag head 1 will hereby follow a course running substantially along the line 80.

As shown in FIG. 1, the suction conduit is provided in another variant with a second steering device in the form of a propeller 60 which, if desired, can move the drag head simultaneously with rudder blade 10. This provides for a still better controllability of the drag head, particularly in harder ground surfaces.

Referring to FIG. 3, a possible embodiment is shown of a device for controlling the steering device according to the invention. The device comprises a computer (CPU) which performs optimizing calculations on the basis of information collected via the (digital) network in the form of incoming signals, coming from instruments such as a GPS system, DTM or a DPDT system (non-limitative list) incorporated in the network. Incoming signals comprise, but are not limited to, the navigating speed 42, the position 43 of the drag head and the current position 46 of the rudder, optionally supplemented with other relevant input data 44, such as for instance the technical possibilities of the trailing suction hopper dredger. The result of the calculation results at least in a control signal 45 for a new position of the rudder. The refreshed data are optionally visualized by sending a modified signal 41 to a screen or to a DPDT system.

The signals (1-6) are processed, after which the device transmits control signals 5 via the digital network to the steering device for the purpose of controlling this latter, or wherein information 41 is shown on a digital screen, on the basis of which an operator carries out control of the steering device. The computer calculates the control 45, which preferably comprises at least that route of the drag head which minimizes the optimum criterion (the ‘optimum’ route). The thus calculated control 45 is continuously modified by the computer as a function of the changes recorded by the instruments.

Referring to FIG. 4, a method for excavating ground (50) is shown, wherein a floating device in the form of a trailing suction hopper dredger (100) is provided. Drag head (1) of trailing suction hopper dredger (100) comprises a suction conduit (4) which is lowered under water at an oblique angle with a winch at the rear thereof until drag head (1) makes contact with the bottom (50). The drag head is dragged underwater over bottom (50) so that soil is loosened and discharged via suction conduit (4). According to the invention steering means (10) of drag head (1) are controlled by means of control means (30) such that drag head (1) moves out of the navigating direction (110) and follows a route (115). A prior art drag head is only capable of following route (116). The (desired) position (120) of drag head (1) to be reached is shown in broken lines in FIG. 4. The current position (130) of drag head (1) is shown in full lines. The desired position (120) cannot be reached by following the route (110) of the trailing suction hopper dredger (100). The optimum criterion in the present example comprises of reaching the desired position (120).

The invention is not limited to the above described embodiment, and modifications could be made thereto to the extent these fall within the scope of the appended claims.

1. Excavating device, comprising a floating device which can be moved in a navigating direction and to which a drag head (1) is attached which during use is dragged over the bottom (50) and herein loosens soil, and a suction conduit (4) which connects to the drag head (1) and which discharges the loosened soil, characterized in that the excavating device is provided with a steering device (10) for moving the drag head (1) out of the navigating direction.

2. Excavating device as claimed in claim 1, characterized in that the excavating device comprises control means (30) for operating the steering device (10) from the floating device.

3. Excavating device as claimed in claim 1 or 2, characterized in that the steering device (10) comprises a rudder blade, wherein the rudder blade extends in a substantially vertical plane and during use engages with a side edge thereof in the ground.

4. Excavating device as claimed in claim 3, characterized in that the control means comprise a hydraulic cylinder which engages on the rudder blade.

5. Excavating device as claimed in claim 1 or 2, characterized in that the steering device (10) comprises a propeller, the rotation axis of which extends substantially transversely of the navigating direction.

6. Excavating device as claimed in claim 1 or 2, characterized in that the steering device (10) comprises means adapted to distribute the friction force of the drag head on the bottom unequally relative to the navigating direction, whereby the drag head can make a transverse movement.

7. Excavating device as claimed in claim 1 or 2, characterized in that the steering device (10) comprises means adapted to shift the reaction force relative to the middle of the drag head as a result of the downward pressure of the drag head on the bottom, whereby the drag head can make a transverse movement.

8. Excavating device as claimed in any of the foregoing claims, characterized in that the drag head is provided with the steering device.

9. Excavating device as claimed in any of the foregoing claims, characterized in that the suction conduit is provided with the steering device.

10. Excavating device as claimed in any of the foregoing claims, characterized in that the excavating device is provided with a plurality of steering devices for the purpose of moving the drag head (1) out of the navigating direction.

11. Method for excavating ground (50), wherein an excavating device as claimed in any of the foregoing claims is provided, the drag head (1) of which is lowered under water with the suction conduit (4) at an oblique angle with a winch at the rear of the floating device until the drag head makes contact with the bottom (50), is subsequently dragged underwater over the bottom (50) so that soil is loosened and discharged via the suction conduit (4), and wherein the steering device (10) is controlled by means of the control means (30) such that the drag head (1) moves out of the navigating direction.

12. Computer program which comprises program instructions for having a computer perform the method as claimed in claim 11.

13. Computer program as claimed in claim 10, characterized in that the computer program is arranged on a physical carrier.

14. Computer program as claimed in claim 12, characterized in that the computer program is at least partially stored in a computer memory.

15. Computer adapted to run a computer program as claimed in any of the claims 12-14.
